(19) United States
(12) Patent Application Publication
(10) Pub. No.: US 2010/0310952 A1
(43) Pub. Date: Dec. 9, 2010

(54) OIL-BEARING SANDS AND SHALES AND THEIR MIXTURES AS STARTING SUBSTANCES FOR PRODUCING SILICON NITRIDE AND/OR SILICON CARBIDE

(75) Inventor: Florian Krass, Weggis (CH)

Correspondence Address: DUANE MORRIS LLP - (prev. San Francisco);IP DEPARTMENT, 30 SOUTH 17TH STREET, PHILADELPHIA, PA, 19103-4196, US

(73) Assignee: SINCONO AG, Zug (CH)

(21) Appl. No.: 12/790,756

(22) Filed: May 28, 2010

Related U.S. Application Data
(63) Continuation-in-part of application No. 11/746,608, filed on May 9, 2007, now abandoned.

(30) Foreign Application Priority Data
May 10, 2006 (DE) DE102006021960.0
Oct. 29, 2006 (EP) EP06022578.6

(51) Int. Cl. H01M 8/06; C01B 31/36; C01B 21/068; C01B 33/12; C01B 3/04

(52) U.S. Cl. 429/423; 423/345; 423/344; 423/335; 423/658.2

(57) ABSTRACT

Oil sand or other naturally occurring oil-containing mixtures are used to produce SiC and/or Si₃N₄. In a subsequent step, the Si₃N₄ is employed to produce ammonia (NH₃).

### CROSS-REFERENCES TO RELATED APPLICATIONS

This application claims the priority of the application DE 10 2006 021 960.0 having the title “Ölhaltige Sande und Schiefer und ihre Gemische als Ausgangssubstanzen zur Darstellung von kristallinem Silizium und Wasserstoffgas sowie zur Herstellung von Siliziumnitrid, Siliziumcarbid und Silanen”, which was filed on 10 May 2006.

This application further claims the priority of the application EP 06 022 578.6 having the title “Ölhaltige Sande und Schiefer und ihre Gemische als Ausgangssubstanzen zum Binden oder Zerlegen von Kohlenstoffdioxid und Nox, sowie zur Darstellung von kristallinem Silizium und Wasserstoffgas sowie zur Herstellung von Siliziumnitrid, Siliziumcarbid und Silanen”, which was filed on 29 Oct. 2006.

The present application is a continuation-in-part of the U.S. patent application Ser. No. 11/746,608, which was filed on 9 May 2007.

All applications are incorporated herein by reference in their entirety for all purposes.

### BACKGROUND OF THE INVENTION

Oil-bearing sands, oil-bearing shales and their mixtures are quite common, but it is very difficult to use them in way that is economically and ecologically sound. Well known are the geological oil shales in Canada or the diatomeous earth in various geological formations or asphalt. The reserves of oil-bearing sands (SiO₂) and shales (SiO₂+[CO₃]²) are known to exceed the world oil reserves multiple times over. The technical methods applied for separating oil and minerals of these naturally occurring mixtures are currently ineffective and too costly.

The term oil shale generally refers to any sedimentary rock that contains solid bituminous materials (called kerogen) that are released as petroleum-like liquids when the rock is heated in the chemical process of pyrolysis. Oil shale was formed millions of years ago by deposition of silt and organic debris on lake beds and sea bottoms. Over long periods of time, heat and pressure transformed the materials into oil shale in a process similar to the process that forms oil. However, the heat and pressure were not as great. Oil shale generally contains enough oil that it will burn without any additional processing, and it is known as “the rock that burns”.

Oil shale and other naturally occurring oil-bearing mixtures can be mined and processed to generate oil similar to oil pumped from conventional oil wells. However, extracting oil from these mixtures is more complex than conventional oil recovery and currently is more expensive. The oil substances in oil shale are solid and cannot be pumped directly out of the ground. The mixture must first be mined and then heated to a high temperature (a process called retorting). The resultant liquid must then be separated and collected. An alternative, but currently experimental process, referred to as in situ retorting, involves heating the mixture while it is still underground, and then pumping the resulting liquid to the surface.

While naturally occurring oil-bearing mixtures are found in many places worldwide, by far the largest deposits in the world are found in the United States in the Green River Formation. Estimates of the oil resource in place within the Green River Formation range from 1.2 to 1.8 trillion barrels. Not all resources in place are recoverable. However, even a moderate estimate of 800 billion barrels of recoverable oil from oil shale in the Green River Formation is three times more than the proven oil reserves of Saudi Arabia. Present U.S. demand for petroleum products is about 20 million barrels per day. If oil shale could be used to meet a quarter of that demand, the estimated 800 billion barrels of recoverable oil from the Green River Formation would last for several centuries.

More than 70% of the total oil shale acreage in the Green River Formation, including the richest and thickest oil shale deposits, is under federally owned and managed lands. Thus, the federal government directly controls access to the most commercially attractive portions of the oil shale resource base.

While oil shale has been used as fuel and as a source of oil in small quantities for many years, few countries currently produce oil from oil shale on a significant commercial level. Many countries do not have significant oil shale resources, but in those countries that do have significant oil shale resources, the oil shale industry has not developed because, historically, the cost of oil derived from oil shale has been significantly higher than conventional pumped oil. The lack of commercial viability of oil shale-derived oil has in turn inhibited the development of better technologies that might reduce its cost.

Relatively high prices for conventional oil in the 1970s and 1980s stimulated interest and some development of better oil shale technology, but oil prices eventually fell, and major research and development activities largely ceased. More recently, prices for crude oil have again risen to levels that may make oil shale-based oil production commercially viable, and both governments and industry are interested in pursuing the development of oil shale as an alternative to conventional oil.

Oil shale and the other naturally occurring oil-bearing mixtures can be mined using one of two methods: underground mining using the room-and-pillar method or surface mining. After mining, the mixture is transported to a facility for retorting, a heating process that separates the oil fractions of oil shale from the mineral fraction. The vessel in which retorting takes place is known as a retort. After retorting, the oil must be upgraded by further processing before it can be sent to a refinery, and the spent shale or sand must be disposed of. Spent shale or sand may be disposed of in surface impoundments, or as fill-in graded areas. It may also be disposed of in previously mined areas. Eventually, the mined land is reclaimed.

Both mining and processing of naturally occurring oil-bearing mixtures involve a variety of environmental impacts, such as global warming and greenhouse gas emissions, disturbance of mined land, disposal of spent shale or sand, use of water resources, and impacts on air and water quality. The development of a commercial oil shale industry in the United States would also have significant social and economic impacts on local communities. Other impediments to development of the oil shale industry in the United States include the relatively high cost of producing oil from oil shale and the lack of regulations to lease oil shale.

Natural asphalt occurs at multiple locations of the earth, but is currently mined on a commercial scale primarily in Trinidad.

Sand occurs in greater or lesser concentrations everywhere on the surface of the earth. A majority of the sand comprises quartz (silicon dioxide; SiO₂).

The aforesaid are mixtures between Silicates, silicon dioxide (SiO₂), some other minerals and hydrocarbons or even carbon but until now it is difficult to impossible to economically use them.

Especially the separation of combustible hydrocarbon and carbon from the non-combustible minerals, like SiO₂ and other minerals (such as sodium carbonate minerals) of such mixtures, is difficult. Most commercial combustion processes cannot be used.

Certain rocks of the Green River Formation also comprise sodium carbonate minerals.

### SUMMARY OF THE INVENTION

The present invention provides a method of producing energy from oil, sand, oil shale or a tar mixture by first heating them to, in a preferred embodiment, produce silicon, water and carbon. Silicon nitride (Si₃N₄) and/or silicon carbide (SiC) are then produced by blowing in gaseous nitrogen in an oxygen-free combustion zone in an exothermic reaction.

Up to this point, no one has arrived at the idea of using the aforesaid naturally occurring mixtures, such as oil-bearing sands (SiO₂), oil-bearing shale (SiO₂+[CO₃]²), or tar-bearing sands or shales, and other mixtures and, in addition, to obtain new raw materials from the products of such a novel method.

Instead of using naturally occurring mixtures of sand and oil in this novel method, industrial or natural waste containing hydrocarbons, possibly after admixing with sand, may also be used. The invention can also be used in order to process oil sand mixed with crude oil, as found after an oil-spill.

Using natural asphalt (also referred to as mineral pitch) as a starting material, instead of the oil component, is also conceivable. A mixture made of asphalt with pure sand or with construction rubble which contains a sand component is especially preferable.

Further, according to the invention, oil sand, and the other mixtures mentioned, can be used as starting substance or feedstock to be decomposed (pyrolized) into some carbon dioxide, carbon, carbon monoxide, silicon and silicon carbide if oxygen-free conditions are ensured. Huge quantities of these mixtures can be processed in commercial plants, like fossil resources are combusted in power plants. The processing conditions, however, are different, since oxygen-free conditions are ensured at least during a certain phase of the decomposition (pyrolization).

The silicon carbide may be (simultaneously or subsequently) reacted with nitrogen to form silicon nitride in an exothermic reaction thus producing energy without emitting CO₂.

By adding aluminum or other elemental metals to the reaction mixture, a reduction to elemental or metallic Si is possible.

An object of the present invention is to provide such raw materials and describe their technical production. The chemical findings used in the method are characterized in that the hydrocarbons present in the sand and shales and other mixtures participate in a reaction, and also the SiO₂ is chemically changed by the reaction.

According to the invention the mineral oil of the sands or other mixtures is pyrolyzed at high temperatures. When using a reducing atmosphere carbon itself forms at a suitable pyrolization temperature as a residue similar to graphite. Some of this carbon forms SiC and the oxygen of the SiO₂ reacts to form mainly H₂O. Care must be exerted to have suitable pyrolysis conditions, optionally by adding further hydrocarbon (preferably in gaseous form) to have SiC and water as main products. This may also be helped by a suitable catalyst, like some metals. Alternatively, the sand/hydrocarbon mixture may be reacted exothermally with some oxygen to generate heat and to at least partially oxidize the hydrocarbons producing some CO₂, C, H₂O and SiC depending on the stoichiometric relations between hydrocarbons, oxygen and silicon dioxide.

The endothermally pyrolyzed sand/hydrocarbon mixture comprising SiC, Si and C thereafter may be further reacted.

In a first embodiment this mixture is reacted with pure nitrogen forming Si₃N₄ in an exothermic reaction, whereas the heat produced thereby can be used e.g. in order to produce energy in a well-known steam power plant or the like. The heat released at a respective furnace in the thermal reaction of the main process may drive the turbine of a generator as strongly compressed water steam, for example.

The most important ceramics used in technology—silicon nitride (Si₃N₄: having a hardness similar to diamond) and silicon carbide (SiC: having its noteworthy thermal conductivity)—may be obtained in a mixture when pyrolizing oil sand by selecting suitable stoichiometric conditions between SiO₂ and hydrocarbons and by selecting suitable catalysts. Even a reduction to silicon may occur.

If needed, the crystalline silicon (e.g., as a powder at suitable temperature) may be reacted after ignition directly with pure (cold) nitrogen (e.g., nitrogen from the ambient air) to form silicon nitride, because the reaction is strongly exothermic. (Si₃N₄ is a solid noble gas [Plichta].) The heat thus arising may be used as described above in order to drive a turbine. One may for instance use a method for obtaining nitrogen which is known from making stainless steel using propane gas (propane nitration).

The carbonaceous residue resulting in from the above pyrolysis of oil sand or sand/hydrocarbon mixtures may also be reacted exothermically with the crystalline silicon to form silicon carbide—possibly via silicon.

The mixture thus obtained after pyrolysis in reducing atmosphere without nitrogen—comprising—inter alia—silicon and/or silicon carbide may be reacted with hydrogen gas—preferably in presence of a catalyst (e.g., using a metal, such as magnesium and/or Aluminum as a catalyst).

Further details and advantages of the present invention are described in the following on the basis of exemplary embodiments.

### DETAILED DESCRIPTION OF THE INVENTION

In the following, the present invention is described on the basis of examples. A first example relates to the application of the present invention in a power plant operation, in order to reduce or even eliminate CO₂ discharge while obtaining energy.

According to the present invention, there are many chemical reactions running in a targeted way, in which new chemical compounds (called products) result from the starting materials (also called educts or reactants). The reactions according to the present invention are designed in such a way that CO₂ is not produced, or consumed and/or bound in significant quantities.

In a first exemplary embodiment, sand admixed with mineral oil or oil shales is used as starting materials, for example. These starting materials are transferred into a reaction chamber, for example, in the form of an afterburner or a combustion chamber. CO₂ is blown into this chamber: In the first exemplary embodiment, this CO₂ may be the CO₂ exhaust gas which arises in large quantities when obtaining energy from fossil combustibles and up to now was blown into the atmosphere in many cases. In addition, some (ambient) air is supplied to the chamber. Instead of the ambient air, or in addition to the ambient air, steam or hypercritical H₂O at over 407° C. may be supplied to the method.

Furthermore, nitrogen is added (e.g. to be blown in) at another step of the method, or to the combustion chamber, respectively.

In addition, some catalyst is used. Aluminum is especially suitable. Under suitable environmental conditions, a reduction occurs in the chamber, which may be represented greatly simplified as follows:

$${SiO}_{2} {\to }^{ red . } Si$$

This equation indicates that the quartz component present in the sand, shale or other mixtures is converted into crystalline silicon. This silicon may take part in further reactions—e.g. with gases.

By addition of hydrogen, silanes may be produced.

By addition of nitrogen, silicon nitride may be produced exothermally.

According to the invention the quartz component present in the sand or shale is (partially) converted into crystalline (elemental or metallic) silicon which may react with other substances in the reaction mixture.

The mineral oil of the sand used assumes the role of the primary energy supplier and supplier of the reducing atmosphere. According to the present invention, it is largely decomposed pyrolytically into hydrogen (H₂), water and a compound similar to graphite at elevated temperatures (preferably at temperatures above 1000° C.). The hydrogen is withdrawn from the hydrocarbon chain of the mineral oil and may react with the oxygen contained in the SiO₂ to form H₂O.

In a second exemplary embodiment, the present invention is applied in connection with a pyrolysis method of Pyromex AG, Switzerland. The present invention may also be used as a supplement or alternative to the oxyfuel™ method. Thus, for example, using the present invention, heat may be obtained by an energy cascade according to the following approach. When adding Aluminum, additional heat is generated and with combustion of oil sand (instead of oil or coal) with oxygen (O₂) and, if needed, also nitrogen (N₂) (Wacker accident). If the nitrogen coupling to silicon compounds is needed, a pure nitrogen atmosphere may be achieved from ambient air by combustion of the oxygen component of the air with a hydrocarbon—like those present in the oil sand, shale or tar, or by adding additional hydrocarbons, e.g. propane gas (known from propane nitration).

Like silicon carbide, silicon nitride is a wear resistant material which can be or is used in highly stressed parts in mechanical engineering, turbine construction, chemical apparatus, and engine construction.

Further details on the chemical proceedings and energy processes described may be inferred from the following pages.

Silicon combusts with nitrogen to form silicon nitride at 1350° C. The reaction is exothermic

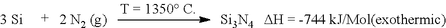

Silicon reacts slightly exothermically with carbon to form silicon carbide.

Si+C→SiC ΔH=−65.3 kJ/Mol (exothermic)

In addition, silicon carbide may be obtained endothermically directly from sand and carbon at approximately 2000° C.:

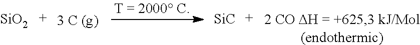

According to the invention, large volumes of the mixtures mentioned can be processed in a commercial plant, pretty much like fossil resources are combusted in power plants. The processing conditions, however, are different, since oxygen-free conditions are ensured at least during a certain phase of the decomposition (pyrolization). In a preferred embodiment, the respective mixture is mined, excavated or exposed. Then the mixture is conveyed to the plant. At the plant, it is fed into a heating zone. In the heating zone the decomposition (pyrolization) takes place as a result of which silicon, water and carbon are provided. In the same heating zone or in a separate combustion zone, gaseous nitrogen is inserted (e.g. blown into), thus producing Si₃N₄ and/or SiC from the silicon as energy carriers in an exothermic reaction. This means that certain steps or during a certain phase of the process oxygen-free conditions and during another step or during another phase of the process a nitrogen-rich atmosphere are provided.

At the end of this process, the Si₃N₄ and/or SiC still contains heat energy. If Ammonia (NH₃) is to be produced, the heat energy can be used to facilitate or support the reaction of Si₃N₄ with water, vapor or a basic substance (e.g. NaOH). This subsequent process step produces Ammonia (NH₃) and silicon dioxide. The Ammonia (NH₃) can be employed as energy carrier, since it can be used in a fuel cell to produce electric energy or since it can be caused to release the hydrogen.

According to the present invention the silicon compounds, fractions or portions of the oil-bearing mixture are made to react with the nitrogen (called nitrogenation). The mixture releases oxygen and, depending on their actual stoichiometry other elements, such as carbon, or molecules, such as CO₂. At the same time nitrogen is attached. This means that a changeover of atoms takes place. This changeover is characterized by a change of the bonding partners. The essential changeover of the invention is the replacement of oxygen with nitrogen. This changeover is illustrated by the following simplified 3-step or 4-step equations:

SiO₂→Si→Si₃N₄

and/or

SiO₂→Si→SiC→Si₃N₄.

The respective reactions are typically taking place in parallel or simultaneously. The overall reaction process is controlled or influenced by the stoichiometry of the feedstock mixture and the stoichiometry of the reaction partners (such as hydrocarbon gas and nitrogen gas).

In a preferred embodiment, the mixture is pre-treated by exposing it to liquid nitrogen. Due to this pre-treatment, the mixture's effective surface is drastically increased. The pre-treatment should preferably be carried out so as to provide flakes, grains or a sponge-like structure. The mixture could for instance be pressed through a nozzle while combining it with the liquid nitrogen, or the nitrogen could be blown in from the side after the mixture has left a spray nozzle.

Due to the surface enlargement, the subsequent decomposition (pyrolysis) and nitrogenation are much more energy efficient and quick. As a side effect, the surface enlargement ensures that the reactions are taking place at lower temperatures (preferably at temperatures below 1000° C. or even below 800° C.).

The pre-treatment should be carried out so that the mixture is transformed into a bosonic state (a state where cold bosons of the mixture merge to form a single super-particle) or a fermionic condensate (a state where the elements of the mixture form a single object) where all elements or reaction partners are brought into alignment or form pairs (called pairing). This ensures that the reactions are taking place at lower temperatures (preferably at temperatures below 1000° C. or even below 800° C.).

The pre-treatment could also be carried out using a vortex stream to provide for a surface enlargement of the mixture, before this mixture undergoes the next process step(s).

The producing of silicon carbide and silicon nitride from oil sand and other mixtures is addressed in further detail below.

The ceramic materials silicon nitride Si₃N₄ and silicon carbide SiC may be obtained from an oil sand or other mixture having approximately 30 wt.-percent petroleum via a multistage process. In order to be able to deal with the mixture of greatly varying hydrocarbon compounds known as petroleum, which is very chemically complex, in a stoichiometrically meaningful way, the formula C₁₀H₂₂, which actually stands for decane, is used in place of the petroleum. Sand, a material which is exactly described by the formula SiO₂, is in a weight ratio of 70% to 30% with the petroleum contained therein. The oil sand is thus described in a coarse approximation by the formula SiO₂+C₁₀H₂₂, SiO₂ contributing a molecular weight of 60 g/mole and decane contributing a molecular weight of 142 g/mole. If one takes 100 g oil sand, 70 g SiO₂ and 30 g “decane” or petroleum are provided. If the material quantities of SiO₂ and “decane” contained therein are worked out, one obtains for SiO₂:

n=(70 g)/(60 g/mole)≈1.167 mole SiO₂

And for petroleum:

n=(30 g)/(142 g/mole)≈0.211 mole C₁₀H₂₂

If both mole numbers are multiplied by 5, one obtains 5.833 mole for SiO₂ and 1.056 mole for C₁₀H₂₂, which makes about 6 mole SiO₂ for a mole of C₁₀H₂₂. Therefore, the formula 6 SiO₂+1 C₁₀H₂₂ may be used in a good approximation for oil sand.

The preparation of silicon nitride Si₃N₄ from oil sand is performed as follows: first, the oil sand is heated in an oxygen-free atmosphere to an elevated temperature (e.g. to 1000° C.). Silicon changes the bonding partner and forms silicon carbide SiC, instead of the high temperature reaction (equation I), which occurs at 2000° C. and consumes a large amount of energy, a more energetically favorable reaction pathway may also be found.

SiO₂+3C→SiC+2CO (I)

This SiC can be reacted exothermally with N₂ to form Si₃N₄. This reaction may be controlled by the amount of available N₂—e.g. by controlling the pressure and/or concentration of N₂ used in the reaction. It is possible to pyrolize oil sand or the other mixtures in the presence of N₂ thus obtaining a mixture of SiC, Si₃N₄ and H₂O. The reaction may be helped by means of a suitable catalyst, like metal ions (iron, molybdenum and other metals of Group VIII are preferred).

If one starts with 1 kg oil sand, 700 g silicon dioxide and 300 g “decane” are contained therein. Converted into the material quantities, n=11.67 mole results for silicon dioxide and n=2.11 mole results for “decane”.

The synthetic pathway described may be performed using the suggested reaction equations if the appropriate thermodynamic favorable temperatures are maintained. Therefore, a clear synthetic pathway for preparing silicon nitride Si₃N₄ and silicon carbide SiC has been shown, which will be described once again supplemented with the required operating temperatures.

What is claimed is:

1. A method for producing energy from oil sand, oil shale or a tar mixture, having the following steps:
introducing a silicon dioxide/hydrocarbon-mixture into a heating zone to obtain silicon, water and carbon,
blowing gaseous nitrogen into an oxygen-free combustion zone to produce silicon nitride (Si₃N₄) and/or silicon carbide (SiC) from the silicon in an exothermic reaction.

2. The method according to claim 1, wherein heat generated from the reaction for preparing the silicon nitride (Si₃N₄) is used to heat said oil sand, oil shale or a tar mixture.

3. The method according to claim 1, wherein one or more of the reactants is rotationally blown into said heating zone.

4. The method according to claim 1, further comprising reacting the silicon nitride (Si₃N₄) with water or a base to generate heat, ammonia (NH₃) and silicon dioxide (SiO₂).

5. The method according to claim 4, wherein said ammonia (NH₃) is used in a subsequent step to produce electricity in a fuel cell.

6. The method according to claim 4, wherein said ammonia (NH₃) is used in a subsequent step to release hydrogen.

7. The method according to claim 1, wherein the heat from said exothermic reaction is used for generating current.
